(19) United States
(12) Patent Application Publication
(10) Pub. No.: US 2015/0120521 A1
(43) Pub. Date: Apr. 30, 2015

(54) GENERATING SOCIAL GRAPHS USING COINCIDENT PAYMENT CARD TRANSACTION DATA

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 14/063,479

(22) Filed: Oct. 25, 2013

(51) Int. Cl. G06Q 40/00

(52) U.S. Cl. CPC G06Q 40/00
USPC 705/35

(57) ABSTRACT

The present disclosure relates to a method and a system for generating social graphs using payment card transaction data. The method involves retrieving, by a financial transaction processing entity, information from one or more databases. The information includes purchasing and payment activities attributable to payment cardholders. The information is analyzed to determine coincident purchasing and payment transaction information of the payment cardholders. The coincident purchasing and payment transaction information is then analyzed to determine social relationships of the payment cardholders. One or more social graphs are generated based on the social relationships of the payment cardholders. The social graphs comprise multi-node graphs having edges or connectors linking the nodes. The payment cardholders are represented by the nodes. A social relationship between the payment cardholders is represented by the edges or connectors linking the nodes. The attributes of the edges or connectors are based upon information describing a characteristic of the relationship.

### BACKGROUND OF THE DISCLOSURE

1. Field of the Disclosure

The present disclosure relates to a method and a system for generating social graphs using coincident payment card transaction data. In particular, the present disclosure relates to a method and a system for social network analysis of coincident purchasing and payment activities of payment cardholders.

2. Description of the Related Art

A social graph consists of nodes that represent people or groups with whom an individual is connected comprising connections or edges, representing relationships such as work, friendship, interests, and location.

There are many applications of social graphs, as seen in marketing applications, email spam detection and fraud prevention. To date, all known methods of linking social graphs with payments data have utilized a direct link from a social profile to a payment card account, which is in turn associated with payment history.

For example, bust out fraud is a type of fraud in which a cardholder tries to gain the largest credit line possible, and then spends his or her entire credit line with no intention of repayment. This behavior could be prompted, for example, by an anticipation of expatriation, or to convert merchandise to cash at a profit exceeding the collections amount. Unlike application fraud, it usually involves a long-term, deliberate, manipulation of financial institutions and practices to maximize the value of the fraud, by first posing as a good customer before maxing out one's credit and disappearing.

This type of fraud may or may not involve identity theft. However, it is known that many bust out artists do not work alone, but may be part of a team of people who are systematically attacking credit unions and banks once they have studied the financial institutions' programs. Moreover, small single operators may also influence others in their social circle to engage in bust out fraud schemes once they have succeeded in perpetuating the fraud.

There is currently no known method or system for generating a social graph directly from payments data, without linking a payment account to an independently created social graph. Currently, it is not possible to use a social graph and payments data in an anonymized context, e.g., when the payments data is linked to a social profile. Further, there is currently no known method or system for analyzing payment card transaction data to define social networks and relationships for predicting behaviors, such as bust out fraud.

### SUMMARY OF THE DISCLOSURE

The present disclosure provides a method and a system for generating social graphs using coincident payment card transaction data. In particular, the present disclosure provides a method and a system for social network analysis using social graphs built from coincident purchasing and payment activities of payment cardholders.

The present disclosure also provides a method and a system for analyzing coincident payment card transaction data to define social networks and relationships for predicting behaviors.

In one aspect of the present disclosure, a method and a system are provided for generating social graphs using coincident payments data. In particular, the present disclosure provides a method and system for social network analysis of coincident purchasing and payment activities of payment cardholders, and for predicting behaviors of payment cardholders such as fraudulent behavior, including bust out fraud, using social network analysis of payment card transaction data.

The present disclosure provides a method and a system for generating a social graph directly from coincident payments data, without linking a payment cardholder account to an independently created social graph. The method and system of the present disclosure make it possible to use a social graph and payments data in an anonymized context, which is not possible when the payments data is linked to a social profile.

In accordance with this disclosure, a method is provided in which a financial transaction processing entity retrieves information from one or more databases. The information includes billing activities attributable to the financial transaction processing entity and purchasing and payment activities attributable to payment cardholders. The information is analyzed to determine coincident purchasing and payment transaction information of the payment cardholders. The coincident purchasing and payment transaction information is then analyzed to determine social relationships of the payment cardholders. One or more social graphs are then generated based on the social relationships of the payment cardholders.

The one or more social graphs comprise one or more multi-node graphs having edges or connectors linking the nodes. The payment cardholders are represented by the nodes. A social relationship between the payment cardholders is represented by the edges or connectors linking the nodes. The attributes of the edges or connectors are based upon information describing a characteristic of the relationship.

This disclosure also provides a system that includes one or more databases configured to store information and a processor. The information includes billing activities attributable to a financial transaction processing entity, and purchasing and payment activities attributable to payment cardholders. The processor is configured to: analyze the information to determine coincident purchasing and payment transaction information of the payment cardholders; analyze the coincident purchasing and payment transaction information to determine social relationships of the payment cardholders; and generate one or more social graphs based on the social relationships of the payment cardholders.

The social graphs of the present disclosure can have many applications, for example, marketing, “influencer” identification, fraud detection (e.g., bust-out fraud), crime prediction, counterterrorism, and the like. As used herein, “influencers” are people who persuade their friends, family and colleagues to follow them when they switch allegiances with companies or merchants (e.g., a mobile phone subscriber of a telecom operator switching to a rival telecom operator).

These and other systems, methods, objects, features, and advantages of the present disclosure will be apparent to those skilled in the art from the following detailed description of the preferred embodiment and the drawings.

### BRIEF DESCRIPTION OF THE DRAWINGS

FIG. 1 is a block diagram illustrating a high-level view of system architecture of a financial transaction processing system in accordance with exemplary embodiments.

FIG. 2 is a flow chart illustrating a method for generating social graphs in accordance with exemplary embodiments of this disclosure.

FIG. 3 is a block diagram illustrating a dataset for the storing, reviewing, and/or analyzing of information used in generating social graphs in accordance with exemplary embodiments.

FIG. 4 illustrates information describing characteristics of a relationship that are used in generating social graphs in accordance with exemplary embodiments.

FIG. 5 illustrates metrics associated with edges or connectors that are used in generating social graphs in accordance with exemplary embodiments.

A component or a feature that is common to more than one figure is indicated with the same reference number in each figure.

### DESCRIPTION OF THE EMBODIMENTS

Embodiments of the present disclosure can now be described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure can satisfy applicable legal requirements. Like numbers refer to like elements throughout.

As used herein, social graphs include both voting graphs and relationship graphs. The relationship graph is a subset of the voting graph. Only edges with cumulative vote weightings exceeding the vote threshold are included in the relationship graph.

As used herein, entities or users can include one or more persons, organizations, businesses, institutions and/or other entities, including but not limited to, financial institutions, and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

Assuming that people with social relationships often have dinner together, meet to obtain coffee, or have lunch together, makes it possible to define a social relationship between two payment cardholders. More specifically, a social relationship is implied whenever two payment cardholders make purchases at the same merchant in temporal proximity.

Temporal proximity can be defined as “immediately before/after each other” that implies that the two individuals were standing next to each other in line at the associated merchant location, or it can include any two customers who made purchases at the same merchant within a threshold amount of time (where the threshold is also limited by any purchases made by one of the payment cardholders at a different merchant).

While a large number of ‘relationships’ will be defined by such a method, it is understood that a voting graph and a relationship graph are preferably constructed from recurring ‘relationships’, preferably identified at a variety of merchants and times of day. In this fashion, the large number of encounters between two payment cardholders strengthens the quality of the voting graph and the relationship graph.

This can take the form of each “relationship” being associated with two payment cardholders, the time between their purchases, the time of the purchase, the merchant location of the purchase, and an indication of whether the purchase authorizations were in immediate proximity.

The voting graph and the relationship graph can be defined as the accumulation of the relationship data, with the frequency of purchases in proximity or density of purchases ascribed as an attribute of the edge or edges of the voting graph and the relationship graph. See, for example, http://en.wikipedia.org/wiki/Directed_graph, for a description of directed graphs, or set of nodes connected by edges, where the edges have a direction associated with them. In accordance with this disclosure, the voting graph and the relationship graph have at least one edge connecting two payment cardholders and at most two edges connecting the two payment cardholders (assuming that the direction of relationship is recorded). Furthermore, each relationship can be weighted inversely to the number of people shopping at the merchant simultaneously (e.g., a movie theatre). For purposes of this disclosure, the voting graph and the relationship graph are data structures.

The voting graphs, as described herein, can be constructed to include a single node for each unique entity, and an edge for every cumulative relationship with another entity. The relationship graphs, as described herein, can be constructed to include a single node for each unique payment cardholder, and an edge for every relationship with another payment cardholder with cumulative vote weightings exceeding a predefined vote threshold. In this fashion, a voting graph and relationship graph of all coincident purchases made by friends can be constructed.

The steps and/or actions of a method described in connection with the exemplary embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, so that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, so that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, so that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the disclosure.

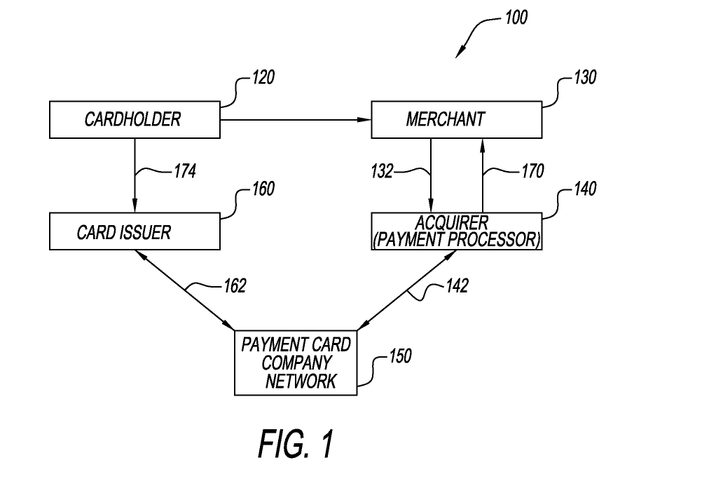

Referring to the drawings and, in particular, FIG. 1, there is shown a four party payment (credit, debit or other) card system generally represented by reference numeral 100. In card system 100, cardholder 120 submits the payment card to merchant 130. The merchant's point of sale (POS) device communicates 132 with his acquiring bank or acquirer 140, which acts as a payment processor. Acquirer 140 initiates, at 142, the transaction on payment card company network 150. Payment card company network 150 (that includes the financial transaction processing company) routes, via 162, the transaction to issuing bank or card issuer 160, which is identified using information in the transaction message. Card issuer 160 approves or denies an authorization request, and then routes, via payment card company network 150, an authorization response back to acquirer 140. Acquirer 140 sends approval to the POS device of merchant 130. Thereafter, seconds later, the cardholder completes the purchase and receives a receipt.

The account of merchant 130 is credited, via 170, by acquirer 140. Card issuer 160 pays, via 150, acquirer 140. Eventually, cardholder 120 pays, via 174, card issuer 160.

In accordance with the method of this disclosure, information that is stored in one or more databases can be retrieved (e.g., by a processor). The information can contain, for example, information including billing activities attributable to the financial transaction processing entity (e.g., a payment card company that is part of the payment card company network 150 in FIG. 1) and purchasing and payment activities attributable to payment cardholders. Illustrative information can include, for example, financial (e.g., billing statements and payments), purchasing information, demographic (e.g., age and gender), geographic (e.g., zip code and state or country of residence), and the like.

In an embodiment, all information stored in the database can be retrieved. In another embodiment, only a single entry (e.g., billing statements and payments) in the database can be retrieved. The retrieval of information can be performed a single time, or can be performed multiple times.

In accordance with this disclosure, the retrieved information is analyzed to determine coincident purchasing and payment transaction information of payment cardholders.

In accordance with this disclosure, the coincident purchasing and payment transaction information of payment cardholders is analyzed to determine social relationships of payment cardholders.

In one embodiment of a method for social network analysis using payment cardholder data, evidence of direct contact (indicated herein as a degree of separation of one (1)) of a first payment cardholder with a second payment cardholder who engages in bust out fraud, for example, is used to predict the probability that the first payment cardholder will also engage in bust-out fraud. In one example, a payment card transaction is identified as being associated with a payment cardholder who is known to have committed bust-out fraud. A ratio or number of payment card transactions associated with the first payment cardholder and the second payment cardholder, which evidence a relationship between the first payment cardholder and the second payment cardholder, is monitored. If the number exceeds a predetermined threshold, an alert is issued to warn of a potential bust-out fraud risk associated with the first payment cardholder.

In another embodiment of a method for social network analysis using payment card transaction data, a relationship weighting is assigned between two payment cardholders by analyzing the payment card transaction data. The relationship weighting indicates a degree of significance to the nature of relationships between payment cardholders.

For example, a frequency of related payment transactions involving two payment cardholders implies a deeper relationship. Payment transactions made during the work day indicate a different type of relationship than those made on weekends or at night. Accordingly, in one embodiment, after payment transaction histories associated with the same payment cardholder are collected and combined, the payment transaction history data associated with each payment cardholder is examined to calculate payment transaction frequency. This data is then used to determine connections between various payment cardholders and the strength of their respective relationships.

For the payment cardholders represented by nodes on a voting graph and a relationship graph, the weight corresponding to the strength of the relationship (represented as an edge on the voting graph and the relationship graph) between the payment cardholders can be determined based on at least one of a frequency of payment card transactions made by the cardholders, the amount of time between their purchases, the time of their purchases, the merchant location of the purchase, and an indication of whether the purchase authorizations were in immediate geographic proximity.

In an embodiment of this disclosure, a relationship weighting (e.g., vote weighting) is assigned between two payment cardholders by analyzing their payment transaction data. The relationship weighting indicates a degree of significance to the nature of relationships between payment cardholders.

For example, a “coincidence” is defined as two different payment cardholders shopping at the same merchant and the same location within a time period τ (tau) (i.e. tau=10 minutes). A “transaction” is defined as a cash-less payment transaction. A “sequential transaction” “B” is defined as the first transaction to occur after a transaction “A”. A ‘horizon’ is the length of time over which the vote weights are examined. (e.g., 1 month or 1 year). A “relationship” between two customers is represented as an edge in the voting graph and the relationship graph. The customers are deemed to know each other based on a sufficient cumulative vote weighting. A “vote threshold” is a numeric value, such that any cumulative vote weightings greater than this value are assumed to imply a social relationship exists between the identified customers. A ‘density’ (D) is defined as the number of transactions within time period tau.

In an embodiment involving coincident sequential transactions only, a vote weight of ‘1’ is assigned for a pair of customers (i.e., payment cardholders), for each time that they make coincident sequential transactions at the same merchant at the same location. For example, if Bob is in line at Starbucks® behind Lisa (assuming they both paid with payment cards), then their transactions would be coincident and sequential and therefore assigned a weight of 1. These vote weights would then be summed over the defined horizon to establish a cumulative vote weighting for each edge in the vote graph. All cumulative vote weightings greater than the vote threshold are incorporated into the relationship graph.

In another embodiment involving coincident transactions with density adjustments, a vote weight of “τ/D²” is assigned for a pair of customers, for each time that they make coincident transactions at the same merchant at the same location (where D=density). For example, Bob and Lisa buy coffee at Starbucks® every morning on the way to work but do not know each other. This metric would capture the frequent proximity of Bob and Lisa's transactions, but would substantially reduce the weight to account for the large number of customers at that time. Note that sequential votes would be an alternative embodiment of this method, but that the description does not require the transactions be sequential. These votes would then be summed over the defined horizon to establish a cumulative vote weighting. All cumulative vote weightings greater than the vote threshold are incorporated into the relationship graph.

The payment transaction data is preferably filtered before forming the social graph, for example, by removing payment card transactions not made at the same merchant, payment card transactions not in temporal proximity, and the like.

In accordance with this disclosure, voting graphs and relationship graphs are generated based on the social relationships of payment cardholders. As an illustrative example of voting graphs and relationship graphs, payment cardholders and merchants interact to buy and sell, respectively, goods or services. Each payment cardholder relationship (e.g., based on payment card transactions) can be represented using a connector (i.e., edge) in a voting graph and a relationship graph, where the payment cardholders are represented using a node in the voting graph and the relationship graph.

In an embodiment, the voting graphs and the relationship graphs comprise one or more multi-node graphs having edges or connectors linking the nodes. The payment cardholders are represented by the nodes. A social relationship between the payment cardholders is represented by the edges or connectors linking the nodes. The attributes of the edges or connectors are based upon information describing a characteristic of the relationship.

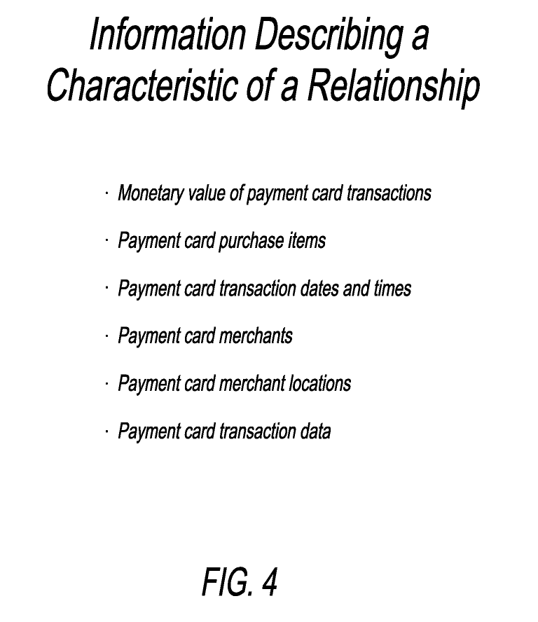

In an embodiment, the information describing a characteristic of the relationship includes a monetary value of payment card transactions, payment card purchase items, payment card transaction dates and times, payment card merchants, payment card merchant locations, and/or payment card transaction data. See FIG. 4.

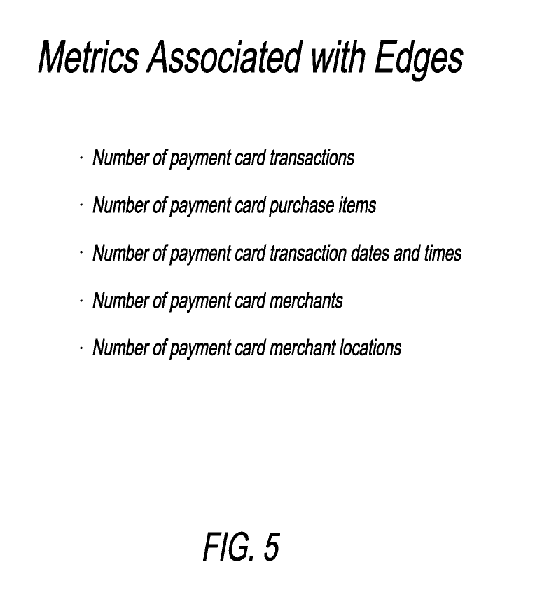

In an embodiment, an attribute of the edges or connectors can be adjusted to represent a corresponding value of a metric. The metric can include a number of payment card transactions, a number of payment card purchase items, a number of payment card transaction dates and times, a number of payment card merchants, and/or a number of payment card merchant locations. See FIG. 5.

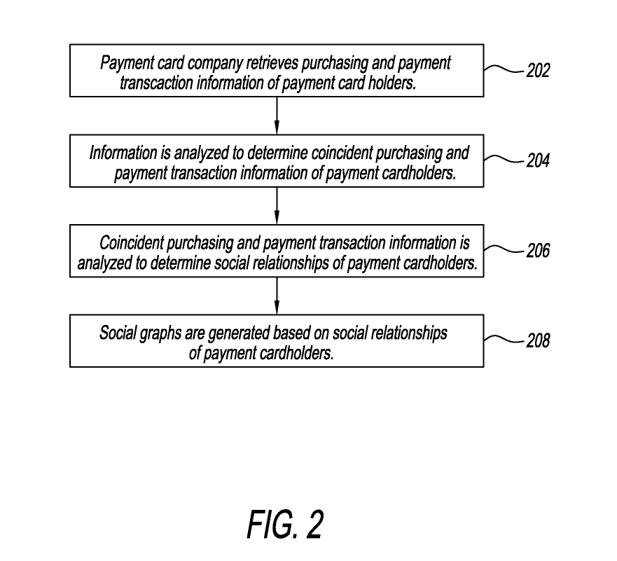

Referring to FIG. 2, the method of generating a voting graph and a relationship graph in accordance with this disclosure involves a payment card company (part of the payment card company network 150 in FIG. 1) retrieving, from one or more databases, information including activities and characteristics attributable to one or more payment cardholders. The transaction information 202 comprises payment card billing, purchasing and payment transactions, and optionally demographic and/or geographic information. The information is analyzed 204 to determine coincident purchasing and payment transaction information of payment cardholders. The coincident purchasing and payment transaction information is analyzed 206 to determine social relationships of the payment cardholders. Voting graphs and relationship graphs are generated 208 based on social relationships of the payment cardholders.

In accordance with the method of this disclosure, the voting graphs and the relationship graphs are analyzed to determine behavioral information of payment cardholders. For example, voting graphs and relationship graphs generated in accordance with the present disclosure can be analyzed in various applications, including marketing, “influencer” identification, fraud detection (e.g., bust-out fraud), crime prediction, counterterrorism, and the like.

Other cardholder attributes that can optionally be part of the information include, for example, geography (e.g., zip code, state or country), and demographics (e.g., age, gender, and the like).

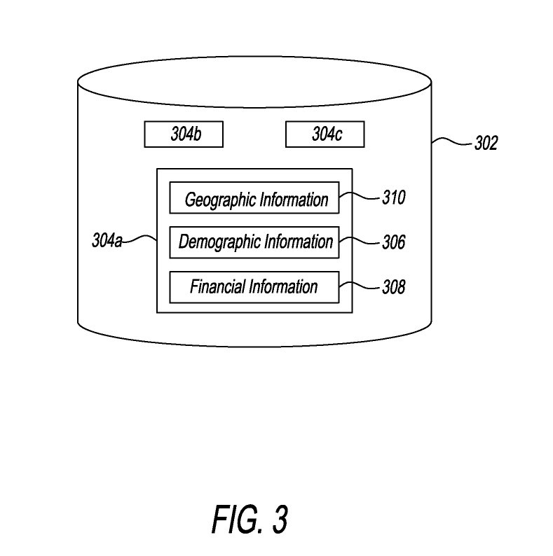

FIG. 3 illustrates an exemplary dataset 302 for the storing, reviewing, and/or analyzing of information used in generating voting graphs and relationship graphs. The dataset 302 can contain a plurality of entries (e.g., entries 304a, 304b, and 304c).

The financial information 308 can contain, for example, information including billing activities attributable to the financial transaction processing entity (e.g., a payment card company that is part of the payment card company network 150 in FIG. 1) and purchasing and payment activities attributable to payment cardholders. Demographic information 306 (e.g., age and gender) can include any demographic or other suitable information relevant to the particular application. The geographic information 310 (e.g., zip code and state or country of residence) can include geographic or other suitable information relevant to the particular application.

One or more algorithms can be employed to determine formulaic descriptions of the assembly of the payment card holder information including payment card billing, purchasing and payment transactions and optionally demographic and/or geographic information, using any of a variety of known mathematical techniques. These formulas, in turn, can be used to derive or generate one or more voting graphs and relationship graphs using any of a variety of available algorithms.

Where methods described above indicate certain events occurring in certain orders, the ordering of certain events can be modified. Moreover, while a process depicted as a flowchart, block diagram, or the like can describe the operations of the present system in a sequential manner, it should be understood that many of the present system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

It should be understood that the present disclosure includes various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving by a financial transaction processing entity, from one or more databases, information including billing activities attributable to the financial transaction processing entity and purchasing and payment activities attributable to payment cardholders;
analyzing the information to determine coincident purchasing and payment transaction information of the payment cardholders;
analyzing the coincident purchasing and payment transaction information to determine social relationships of the payment cardholders; and
generating one or more social graphs based on the social relationships of the payment cardholders.

2. The method of claim 1, wherein the one or more social graphs comprise one or more voting graphs and one or more relationship graphs.

3. The method of claim 1, wherein the one or more social graphs comprise one or more multi-node graphs having edges or connectors linking the nodes, and wherein the payment cardholders are represented by the nodes, and a social relationship between the payment cardholders is represented by the edges or connectors linking the nodes, wherein attributes of the edges or connectors are based upon information describing a characteristic of the relationship.

4. The method of claim 3, wherein the information describing a characteristic of the relationship includes at least one of a monetary value of payment card transactions, payment card purchase items, payment card transaction dates and times, payment card merchants, payment card merchant locations, and/or payment card transaction data.

5. The method of claim 1, wherein the edges or connectors are associated with a metric.

6. The method of claim 5, wherein the metric includes at least one of a number of payment card transactions, a number of payment card purchase items, a number of payment card transaction dates and times, a number of payment card merchants, and/or a number of payment card merchant locations.

7. The method of claim 5, wherein an attribute of the edges or connectors is adjusted to represent a corresponding value of the metric.

8. The method of claim 1, further comprising:
weighting the relationship based on at least one of frequency of payment card transactions made by the payment cardholders, amount of time between their purchases, time of their purchases, merchant location of the purchase, and an indication of whether purchase authorizations were in immediate proximity.

9. The method of claim 1, wherein the one or more social graphs comprise one or more data structures.

10. The method of claim 1, further comprising analyzing the coincident purchasing and payment transaction information to define social networks and relationships for predicting behaviors.

11. A social graph generated in accordance with the method of claim 1.

12. A system comprising:
one or more databases configured to store information including billing activities attributable to a financial transaction processing entity and purchasing and payment activities attributable to payment cardholders;
a processor configured to:
analyze the information to determine coincident purchasing and payment transaction information of the payment cardholders;
analyze the coincident purchasing and payment transaction information to determine social relationships of the payment cardholders; and
generate one or more social graphs based on the social relationships of the payment cardholders.

13. The system of claim 12, wherein the one or more social graphs comprise one or more voting graphs and one or more relationship graphs.

14. The system of claim 12, wherein the one or more social graphs comprise one or more multi-node graphs having edges or connectors linking the nodes, and wherein the payment cardholders are represented by the nodes, and a social relationship between the payment cardholders is represented by the edges or connectors linking the nodes, wherein attributes of the edges or connectors are based upon information describing a characteristic of the relationship.

15. The system of claim 14, wherein the information describing a characteristic of the relationship includes at least one of a monetary value of payment card transactions, payment card purchase items, payment card transaction dates and times, payment card merchants, payment card merchant locations, and/or payment card transaction data.

16. The system of claim 12, wherein the edges or connectors are associated with a metric.

17. The system of claim 16, wherein the metric includes at least one of a number of payment card transactions, a number of payment card purchase items, a number of payment card transaction dates and times, a number of payment card merchants, and/or a number of payment card merchant locations.

18. The system of claim 16, wherein an attribute of the edges or connectors is adjusted to represent a corresponding value of the metric.

19. The system of claim 12, wherein the processor is configured to:
weigh the relationship based on at least one of frequency of payment card transactions made by the payment cardholders, amount of time between their purchases, time of their purchases, merchant location of the purchase, and an indication of whether purchase authorizations were in immediate proximity.

20. The system of claim 12, wherein the one or more social graphs comprise one or more data structures.

21. The system of claim 12, wherein the processor is further configured to analyze the coincident purchasing and payment transaction information to define social networks and relationships for predicting behaviors.

22. A social graph generated in accordance with the system of claim 12.
